(19) United States
(12) Patent Application Publication
(10) Pub. No.: US 2007/0094489 A1
(43) Pub. Date: Apr. 26, 2007

(54) Embedded system that boots from USB flash drive

(75) Inventors: Takaaki Ota, San Diego, CA (US); Dipendu Saha, San Diego, CA (US); Robert Hardacker, Escondido, CA (US)

Correspondence Address: FITCH EVEN TABIN & FLANNERY, 120 SOUTH LASALLE SUITE 1600, CHICAGO, IL, 60603, US

(73) Assignees: Sony Corporation, Tokyo (JP); Sony Electronics Inc., Park Ridge, NJ (US)

(21) Appl. No.: 11/256,315

(22) Filed: Oct. 21, 2005

(51) Int. Cl. G06F 15/177

(52) U.S. Cl. 713/2

(57) ABSTRACT

The present embodiments provide apparatuses, systems and methods for that allow the booting of an embedded system from an off-board memory. In some embodiments, a system is provided that includes a circuit board comprising a processor, a memory, an operating system stored in the memory and utilized to at least in part control processor operation, and an external memory access comprising a first port onboard the circuit board, a local off-board memory, wherein the local off-board memory is coupled to the first port, and a root file system stored in the local off-board memory used while booting the operating system.

### FIELD OF THE INVENTION

The present invention relates generally to embedded electronic devices, and more particularly, to the configuration of embedded systems.

### BACKGROUND

Embedded systems are ubiquitous components that can be incorporated, for example, into consumer electronic devices. Numerous consumer electronic devices such as mobile phones, computers, printers, digital video recorders, televisions and set-top boxes, for example, incorporate embedded systems. Embedded systems typically are self-contained processing systems designed to perform a specific function or set of functions.

Consumer electronic devices have continued to evolve at a rapid pace often with more and more new, different or improved features being packed into the devices. As a result, some embedded systems utilized in consumer electronic devices have become vastly more complex. Since many embedded systems are incorporated into another electronic device, this presents additional challenges when maintaining or upgrading these embedded systems.

The present invention advantageously addresses the above and other needs.

### SUMMARY OF THE EMBODIMENT

The present invention advantageously addresses the needs above as well as other needs through the provision of methods, apparatuses, and systems for use in booting an embedded system from an off-board memory. An apparatus, according to some embodiments, includes a circuit board comprising a processor, a memory, an operating system stored in the memory and utilized at least in part to control processor operation and an external memory access. The external memory access comprises a first port onboard the circuit board, a local off-board non-volatile memory coupled to the first port onboard the circuit board and a root file system stored in the off-board non-volatile memory. The root file system stored in the off-board non-volatile memory is used while booting the operating system.

Some methods and apparatuses further provide for booting an embedded system from an off-board memory by activating a circuit board; copying an operating system from an onboard non-volatile memory into an onboard active memory; initiating execution of the operating system; directing the operating system to use a first root file system located in a local off-board memory; accessing the local off-board memory; and booting the operating system using the root file system in the local off-board memory.

Some methods and apparatuses of present embodiments further provide a consumer electronic device comprising an embedded system; a first port; at least one data bus enabling communication between the embedded system and the port; an external memory access configured to allow access to an off-board first root file system and a first local off-board memory coupled to the first port. The operating system at least is part controls the operation of the processor. The first local off-board memory comprises a first off-board root file system used by the operating system while booting the embedded system.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a consumer electronic device comprising an embedded system according to some present embodiments;

FIG. 2 depicts a simplified block diagram of an embedded system architecture wherein the embedded system accesses an off-board memory to provide a root file system according to some embodiments;

FIG. 3 depicts a simplified block diagram of the architecture of a controller according to some present embodiments;

FIG. 4 depicts a simplified flow diagram of a process for booting the embedded system using a root file system located on an off-board memory using architectures shown in the previous figures and described above, such as the architectures shown in FIGS. 1-3;

FIG. 5 depicts a simplified block diagram of an embedded system architecture wherein the embedded system alternatively boots using an off-board memory to provide a root file system or boots using an onboard root file system;

FIG. 6 depicts a simplified flow diagram of a process for booting the embedded system using a root file system located in an off-board memory using architectures of the present embodiments such as the architectures shown in FIGS. 1-3 and 5;

FIG. 7 depicts a simplified flow diagram of a process for booting the embedded system using a root file system located in an off-board memory;

FIG. 8 depicts a simplified block diagram of a consumer electronic device comprising an embedded system that boots using a root file system from an off-board memory coupled to an external or internal port of the consumer electronic device; and

FIG. 9 depicts a simplified block diagram comprising multiple embedded systems booting using a shared read-only file system in a memory.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The present embodiments provide apparatuses, systems and methods for use in booting an embedded system from an off-board memory. A number of embodiments are provided herein for illustrative purposes only and should not be construed to limit the scope of the present invention.

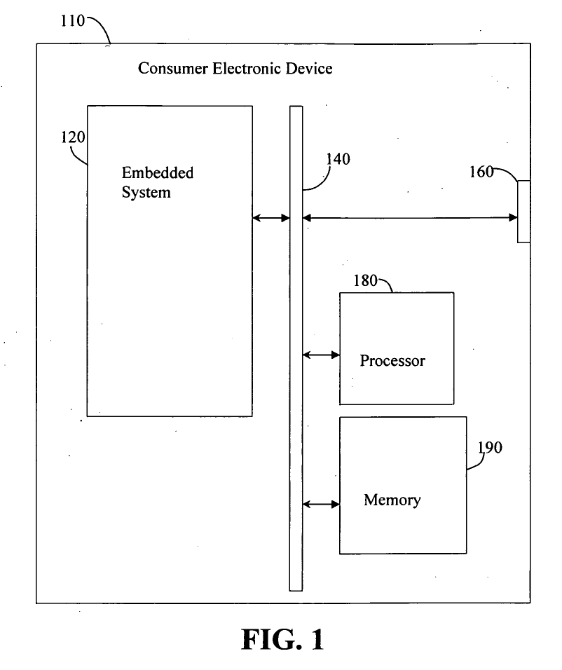

FIG. 1 depicts a simplified block diagram according to some embodiments of a consumer electronic device 110 that includes, for example, comprising a processor 180, a memory 190, a port 160, a data bus 140, and an embedded system 120. The function of the consumer electronic device 110 is at least in part determined by the function of the embedded system 120. The components of the consumer electronic device 110 are linked to one or more data buses 140 and/or directly connected to enable communications among the components. One skilled in the art will recognize that the consumer electronic device 110 depicted in FIG. 1 is merely illustrative of one possible embodiment and that other embodiments of the consumer electronic device 110 may comprise additional components including, for example, display and display driver, audio driver and audio output, multiple instances of the components provided above, and other such components.

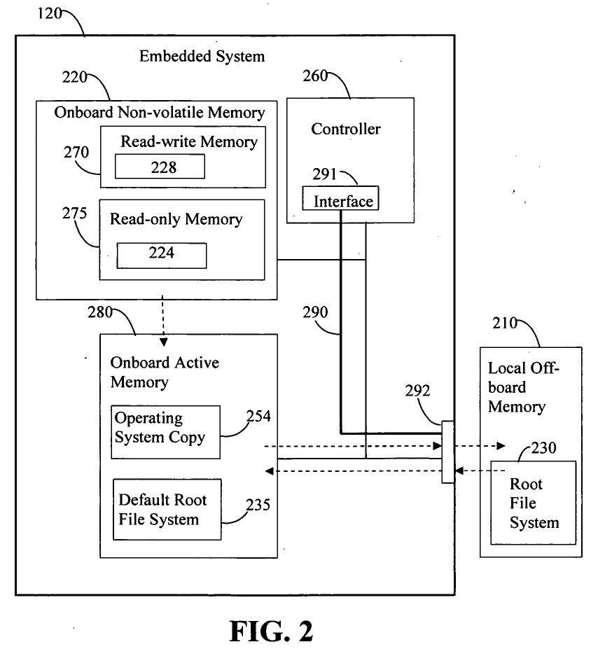

FIG. 2 depicts a simplified block diagram of an embedded system 120 according to some embodiments. The embedded system comprises an onboard non-volatile memory 220, an onboard active memory 280, a controller 260, and an external memory access 290. The embedded system can be implemented through one or more circuit boards, and typically is implemented on a single circuit board. The onboard active memory 280 may be substantially any form of writable memory. For example, in some embodiments, the onboard active memory 280 comprises volatile memory that does not retain its state when not powered, such as a random access memory (RAM) and other such memory. The onboard non-volatile memory 220 may be substantially any form of computer storage that retains its state when not powered, including, but not limited to, erasable programmable read-only memory (EPROM), electrically-erasable programmable read-only memory (EEPROM), flash memory and other such memory and/or combinations of memory. In the present embodiment, the onboard non-volatile memory 220 comprises an onboard read-only non-volatile memory 270 and an onboard read-write non-volatile memory 275. The onboard read-only non-volatile memory 270 may comprise substantially any form of read-only non-volatile memory such as, for example, an EPROM. The onboard read-write non-volatile memory 275 may comprise substantially any form of read-write non-volatile memory such as, for example, a flash memory or EEPROM.

The onboard read-only non-volatile memory 270 further comprises a monitor 228 and the onboard read-write non-volatile memory 275 further comprises an operating system 224. The operating system controls the basic operation of the embedded system. The monitor 228 is typically implemented as software or firmware executed by the controller 260 when the embedded system is powered up or reset. The monitor 228 loads the operating system of the embedded system and initializes the execution of the operating system. The controller 260 may be implemented, for example, through a microprocessor, a microcontroller and/or a system-on-a-chip (SOC). One skilled in the art will recognize that the controller is not limited to these embodiments and that the controller may comprise substantially any electronic component with means for controlling the processing and execution of at least the monitor and operating system software utilized onboard the embedded system.

The external memory access 290 provides the embedded system 120 with the ability to access off-board memory. The external memory access in some embodiments comprises an interface 291 integrated into the controller 260 and a port 292. The external memory access provides access to a local off-board memory 210 containing a root file system 230 that the operating system of the embedded system uses while booting. The root file system includes configuration files that determine the functionality of the operating system and may also include application programs to be utilized by and/or executed by the operating system once the operating system boots up.

In some embodiments, the external memory access 290 comprises a USB port (port 292) and USB interface integrated into a controller or system-on-a-chip device 260. In other embodiments, the external memory access 290 additionally and/or alternatively comprise an onboard bus port (port 292) and bus port drivers to provide an interface to the bus port located in the onboard non-volatile memory 220.

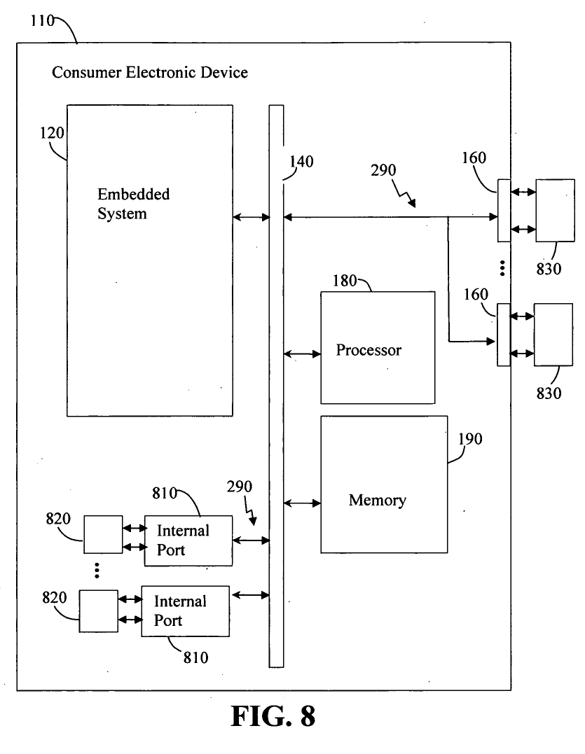

The local off-board memory is a memory external to the embedded system 120, but accessible to the embedded system 120 via the external memory access 290. In some embodiments, the local off-board memory is directly coupled to a port 292 on the embedded system. In other embodiments, the consumer electronic device 110 comprises the local off-board memory 210 and the embedded system 120 accesses the local off-board memory 210 via the external memory access 290. The local off-board memory 210 may comprise a volatile memory such as RAM or a non-volatile memory such as a flash memory. In some embodiments, the local off-board memory 210 may be a USB flash drive directly coupled to the port 292 implemented through a USB port onboard the embedded system. In other embodiments, the consumer electronic device 110 may comprise one or more USB ports and the off-board memory is a USB flash drive coupled to one of the consumer electronic devices USB ports (see FIG. 8).

In some embodiments, the local off-board memory 210 is powered by the port to which it is coupled. For example, in some embodiments, the external memory access 290 comprises a USB port (port 292). USB ports typically provide a 5 volt output that devices connected to the port may use as a power source. USB flash drives, for example, typically contain no onboard power supply and thus depend upon the USB port to which the flash drive is coupled to provide power. The present embodiments are not limited to USB flash drives. One skilled in the art would recognize that substantially any memory that receives power from the port could be substituted for a USB flash drive. For example, in some embodiments, the external memory comprises a Sony Memory Stick™.

When the embedded system is powered up or reset, the monitor stored in the onboard non-volatile memory 220 is executed by the controller in order start the bootstrap process for the embedded system. The monitor creates a copy of the operating system 254 in the onboard active memory 280 using the operating system 224 in onboard non-volatile memory 220. The monitor initializes the operating system execution by the controller 260 in the onboard active memory 280 and directs the operating system to access the root file system 230 through the external memory access 290. The operating system then uses the root file system 230 located in the local off-board memory 210 while booting. The root file system 230 contains files to configure the function of the operating system which in turn determines the function of the embedded system 120. The function of the embedded system 120 can be substantially modified by booting the operating system with a different file system such as a different file system on a different flash memory.

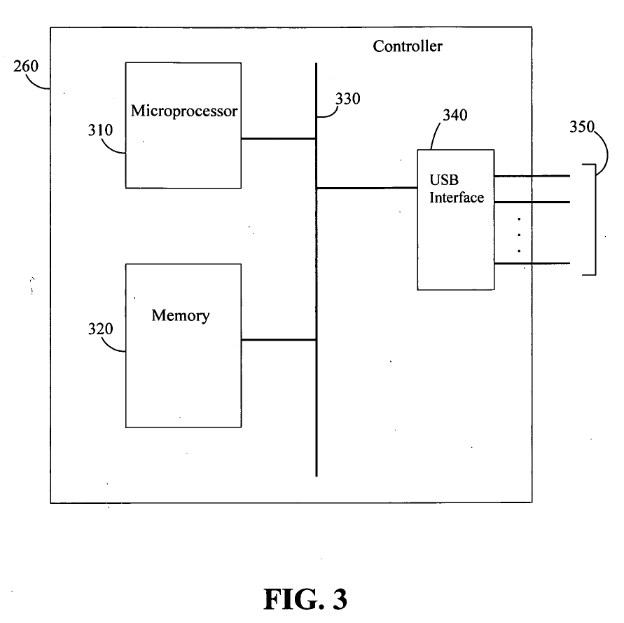

FIG. 3 depicts a simplified block diagram of the controller 260 according to some embodiments. The controller comprises a microprocessor 310, a memory 320, an internal data bus 330, a USB interface 340, and one or more USB connections 350. The internal data bus 330 enables communication among the various components of the controller 260; however, direct coupling can additionally and/or alternatively be used. The USB interface 340 provides one or more USB connections 350 that connect to the onboard USB ports (port 292) on the embedded system 120 (implemented in some embodiments through a single circuit board). The USB interface 340, in some embodiments, implements the interface component 291 of the external memory access 290, and the USB connections 350 communicationally couple the interface 291 and the port 292 of the external memory access 290.

In alternate embodiments, other types of interfaces may be substituted in place of the USB interface 340. For example, a PCI bus interface coupled to a port 292 (such as a bus port or other such port) on the embedded system 120 at least in part implements the external memory access 290 in conjunction with bus port drivers that are part of the operating system 224.

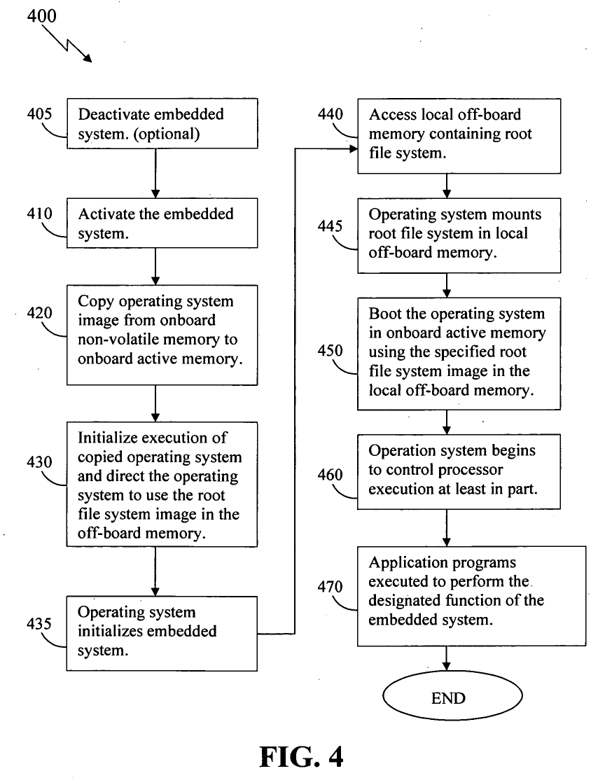

FIG. 4 depicts a simplified flow diagram of a process 400 for booting an embedded system using a root file system located on an off-board memory using architectures shown in the previous figures and described above, such as the architectures shown in FIGS. 1-3. In optional step 405, the embedded system is deactivated. The deactivation or resetting of the embedded system 120 may be accomplished through a variety of means, including but not limited to the consumer electronic device 110 issuing a reset command to the embedded system, the end user or a service technician resetting the consumer electronic device 110 comprising the embedded system 120, through onboard means such as a watchdog timer that triggers a rest of the embedded system 120 in the event of a fault, and/or through other such events. In step 410, the embedded system 120 is activated (i.e. powered up or reset), causing the board to begin initializing for operation. Step 410 includes the execution of the monitor 228 by the controller 260. The monitor 228 is stored in onboard non-volatile memory 220 of the embedded system 120. In step 420, the monitor 228 copies the operating system 224 from onboard non-volatile memory 220 into the onboard active memory 280 to create a copy of the operating system 254. In step 430, the monitor activates the copied operating system (e.g., initiates execution of the operating system software by the controller 260) and directs the operating system to use the root file system 230 located in the local off-board memory 210. In step 435, the operating system initializes the embedded system 120. The operating system then accesses the local off-board memory 210 through the external memory access 290 in step 440. In step 445, the operating system mounts the root file system 230. More specifically, mounting the root file system makes the files in the file system stored on the local off-board memory accessible to the operating system. For example, in some embodiments, when the operating system mounts a file system, the operating system associates a directory with said file system to provide a point of access into the file system for the operating system and application programs to be run on the operating system. In step 450, the operating system boots in onboard active memory 280 using root file system 230 located in the local off-board memory 210. In step 460, the operating system begins controlling the execution of the controller 260 at least in part. In step 470, the operating system begins execution of application programs in order to perform the designated function of the embedded system 120.

The function of the embedded system 120 is typically configurable based upon the root file system provided to the operating system. The root file system contains configuration files that determine and/or dictate the operation of the operating system and may also contain one or more software applications that the operating system launches to perform various functions.

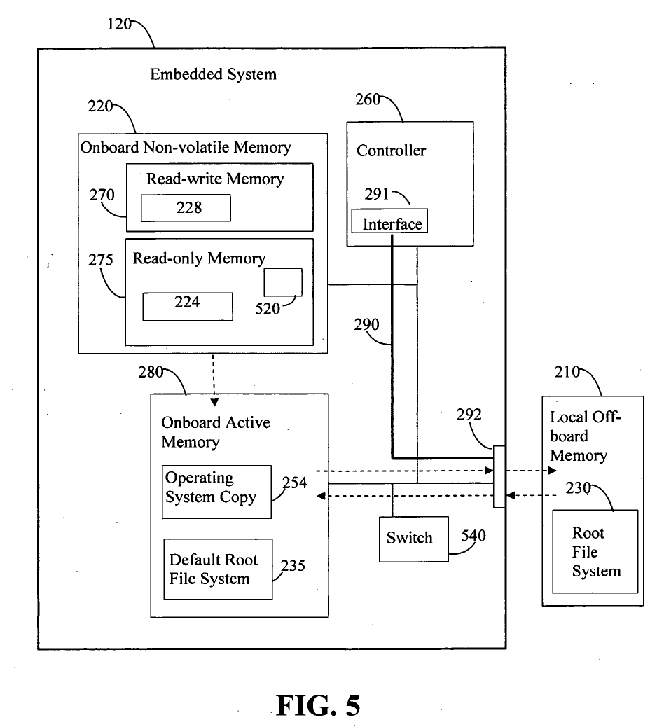

FIG. 5 depicts a simplified block diagram of an embedded system 120 according to some embodiments. The embedded system 120 comprises an onboard non-volatile memory 220, an onboard active memory 280, a controller 260, an external memory access 290, a switch 540, and a local off-board memory 210. In some embodiments, the onboard non-volatile memory includes an onboard read-only non-volatile memory 270 and an onboard read-write non-volatile memory 275. The onboard read-only non-volatile memory 270 contains a monitor 228. The onboard read-write non-volatile memory 275 includes an operating system 224, a default root file system 226, and one or more parameters 520. The external memory access 290 includes an interface 291 that is a component of the controller 260 and a port 292. The interface 291 provides access to the S port 292. The external memory access 290 allows the operating system to access one ore more local off-board memories 210. The onboard active memory 280 includes and/or is configured to include a copy of the operating system 254 as well as a copy of the default root file system 235. The local off-board memory 210 further stores a root file system 230.

The embedded system 120 is configurable to utilize the root file system 230 stored on the local off-board memory 210 or use the copied default root file system 235. The monitor 228 checks the parameter 520 in the onboard non-volatile memory 220 to determine whether the monitor 228 should copy a root file system from the onboard read-write non-volatile memory 275 or to access and use the root file system 230 of the local off-board memory 210. In alternate embodiments, the embedded device 120 includes a switch 540 instead of or in addition to the parameter 520 that is utilized to indicate that the operating system is to use root file system 230 from the local off-board memory 210 or the copied default root file system 235. In some embodiments, the switch 540 comprises one or more physical switches, such as one ore more DIP switches, that allow for the configuration of the embedded system 120. For example, in some embodiments, the switch 540 is set to a default value at the time of manufacture to indicate that the monitor 228 should obtain a root file system from the local off-board memory 210 whenever the embedded system boots yet allow a technician to flip the switch to access the default root file system 235. The switch 540 can additionally or alternatively be implemented in software, for example, that a service technician triggers the software switch through a user interface. For example, some embedded system embodiments comprise a set of buttons that control a menu system through which the service technician configures and tests the embedded system.

In some embodiments, the switch 540 provides service technicians with the ability to diagnose problems with the consumer electronic device 110 or the embedded system 120. The service technician can set the switch to indicate that the monitor 228 shall direct the copied operating system 254 to boot using the root file system 230 of the local off-board memory with a known configuration. The embedded system 120 then boots into a known state in order to facilitate diagnostic testing. After setting switch 540, the service technician reboots the embedded system 120 and performs diagnostics on the system in order to determine if the embedded system is functioning as expected. The root file system 230 may also contain diagnostic applications that further facilitate testing.

When the embedded system 120 is configured to obtain a root file system from the onboard non-volatile memory 220, the monitor 228 copies the default root file system 226 from the onboard non-volatile memory 220 into the onboard active memory 280 to create the copied default root file system 235. Otherwise, when the embedded system 120 is configured to use and/or obtain a root file system from the local off-board memory 210, the monitor initiates the execution of the copied operating system 254 in the onboard active memory 280 and then directs the operating system to access the root file system 230 through the external memory access 290. The operating system then uses the root file system 230 located in the local off-board memory 210 while booting instead of the copied default root file system 235 in the onboard active memory 280.

In some embodiments, when the embedded system 120 is configured to access and use a root file system from off-board memory, the monitor accesses the local off-board memory 210 though the external memory access 290 and copies the root file system 230 from the off-board memory into the onboard active memory 280 to create the copied default root file system 235. The monitor also copies the operating system 224 from the onboard non-volatile memory 220 into the onboard active memory 280. The monitor then initiates the execution of the copied operating system 254 in the onboard active memory 280 and directs the operating system to use the copied default root file system 235 also in the onboard active memory 280. The operating system then boots utilizing the copies root file system and begin to control, at least in part, the execution of the controller 260 to perform the designated function of the embedded system 120.

The present embodiment provides a system and method for booting an embedded system using a root file system from an external memory device. The result is a highly flexible system that can be readily reconfigured by replacing the root file system in the external memory device. More specifically, the root file system provides files used to configure the operating system of the embedded system and may also include application programs to be executed by the operating system once the embedded system is initialized. The operating system configuration and the application programs typically determine the function of the operating system.

In some embodiments, the hardware and the onboard operating system of the embedded system can be substantially standardized in the present embodiments. Software customization often determines much of the functionality of an embedded system. As a result, a variety of electronic devices can use the same“standard” embedded system hardware with differing root file systems that are tailored to configure the embedded system hardware for specific operations and/or host electronic devices. For example, a digital video recorder and a set-top box may include a similar or duplicate embedded system as a component, but the function of the embedded system would be particularized for each of these devices by providing an appropriate root file system.

The ability to use standard hardware and operating systems in the embedded systems minimizes manufacturing and maintenance costs of both the embedded systems and the consumer electronic devices utilizing the embedded systems. Some implementations of some present embodiments, for example, provide for cost-effective maintenance, since the operation of the embedded system can be readily modified by issuing a replacement file system containing altered and/or new operating system configuration files or application programs. Replacement file systems could be issued, for example, to correct identified or known problems of an embedded system or provide updated or new functionality. The present embodiments advantageously allow for the correction of software and configuration problems, and/or allow for the enhancing and/or reconfiguring of embedded systems. For example, a root file system containing updated device drivers can be obtained and/or downloaded from the manufacturer's website onto a USB flash drive and the embedded system rebooted with the downloaded root file system on the USB flash drive.

The present embodiments also advantageously address shortcomings inherent to some other embedded system implementations. For example, some implementations of embedded systems are typically limited to obtaining a root file system from an onboard non-volatile memory. Such implementations typically do not provide the option to go off-board to obtain the root file system. Updating the root file system in the onboard non-volatile memory is cumbersome and typically requires specialized equipment including a host computer configured to copy a new root file system into the onboard non-volatile memory of the embedded system.

Some existing computer system implementations utilize a Network File System (NFS) protocol to access an off-board memory containing a root file system. The NFS is a distributed file system protocol that enables remote file systems to be accessed over a network, enabling the file system contents to be accessed as if the file system were local. However, practical limitations inherent to NFS typically confine NFS-enabled systems to prototyping systems under development. For example, NFS typically requires that a system have network access to a host configured as an NFS server. Embedded systems are generally stand-alone devices that perform a specified function as a component of some other electronic device. As such, NFS is generally not practical for use in embedded systems. Furthermore, the local off-board memory 210 in at least some embodiments is powered by the port to which the local off-board memory 210 is coupled. Typically, NFS servers are computers that require more power than a port can provide. For example, in some present embodiments the port 292 to which the local off-board memory is coupled is a USB port. The typical USB port provides a 5 volt output, which is insufficient to satisfy the power requirements of a typical computer configured as an NFS server.

The present embodiments enable embedded systems to boot from an external memory device. Advantageously, the present embodiments enable updating of the root file system used to boot the embedded system without the burden of updating the root file system in the onboard non-volatile memory. Furthermore, the present embodiments can be utilized in the production version of embedded systems, thereby making it possible to update the root file system for embedded systems in the field, such as those incorporated into a consumer electronic device. For example, a consumer experiencing a problem with his/her consumer electronic device can receive and/or download a root file system containing one or more revised and/or new device drivers for the consumer electronic device from the manufacturer's website onto a USB flash drive. The consumer or technician then plugs the USB flash drive containing the new root file system into a port on the consumer electronic device and the embedded system in the consumer electronic device boots using the new root file system. In addition, some present embodiments provide the ability to download additional new functionality to a functional embedded system. For example, the manufacturer might provide a subscription plan on its website wherein consumers could subscribe for a specific set of services. Once subscribed, the consumers then receive or download the appropriate root file system and reboot the consumer electronic device in order to activate the embedded system using the subscribed functionality.

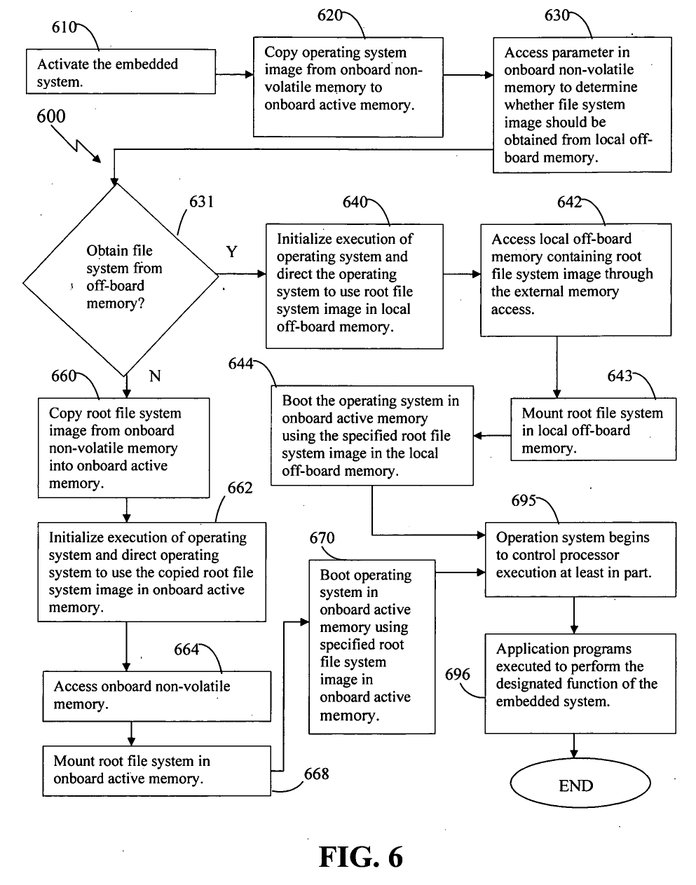

FIG. 6 depicts a simplified flow diagram of a process 600 for alternatively booting an embedded system from off-board or onboard memory. In step 610, the embedded system 120 is activated, causing the embedded system to begin initializing itself for operation. This step includes the execution of the monitor 228 stored in the embedded system's onboard non-volatile memory 220. In step 620, the monitor 228 copies the operating system 224 from the onboard non-volatile memory into the onboard active memory 280 to create the copied operating system 254.

In step 630, the monitor accesses parameter 520 in onboard non-volatile memory 220. The value of parameter 520 indicates whether the monitor should go off-board to utilize a root file system for the operating system of the embedded system to use while booting or whether the monitor should obtain a root file system for the operating system from onboard non-volatile memory 220. The monitor 228 checks the value of parameter 520 in step 631. In step 640, if parameter 520 is set to indicate that the monitor 228 should obtain a root file system off-board, then the monitor initializes the operating system and directs the operating system to use the root file system 230 in the local off-board memory 210. In step 642, the operating system accesses the root file system 230 in the local off-board memory 210 through the external memory access 290. In step 643, the operating system mounts the root file system 230 in the local off-board memory 210 in order to make the contents of the file system accessible to the operating system as if they were local (in onboard memory). The operating system then boots in the onboard active memory 280 using the root file system 230 in the local off-board memory 210 in step 644.

Alternatively, if the value of parameter 520 indicates that a file system should be obtained from an onboard memory, for example, the monitor then copies a default root file system 226 from non-volatile memory 220 into onboard active memory 280 to create copied default root file system 235 in step 660. In step 662, the monitor 228 activates the operating system and directs the operating system to use the copied default root file system 235 in onboard active memory 280. The operating system then accesses the onboard active memory 280 in step 664 in order to locate the copied default root file system 235. The operating system then mounts the copied default root file system 235 in order to make the files available to the operating system in step 668. In step 670, the operating system boots in the onboard active memory 280 using the copied default root file system 235.

In step 695, the copied operating system 254 begins controlling the execution at least in part of the controller 260. Finally, in step 696, the operating system initializes the execution of application programs included as part of the root file system in order to perform one or more designated functions of the embedded system 120.

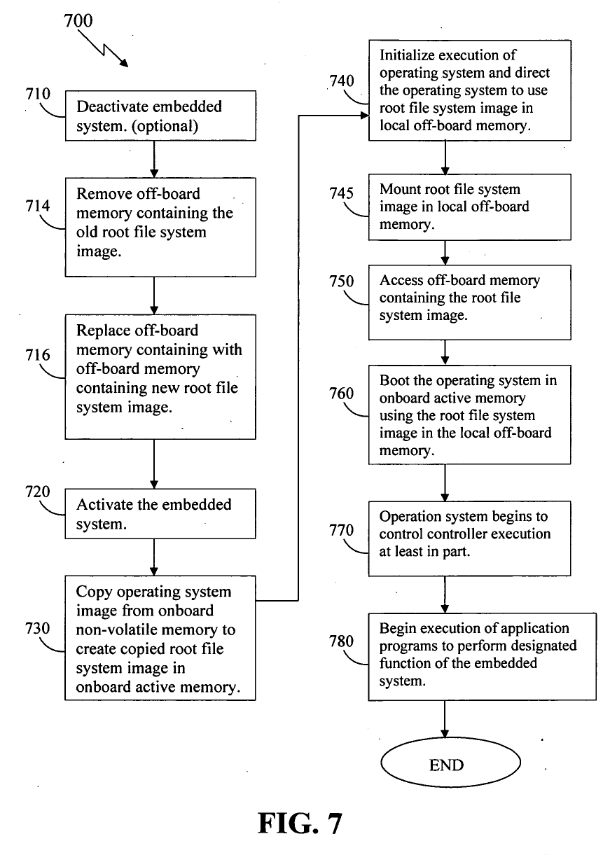

FIG. 7 depicts a simplified flow diagram of a process 700 for booting an embedded system with a new root file system, for example, using architectures shown in the previous figures and described above, such as the architectures shown in FIGS. 1-3 and 5. In optional step 710, the embedded system is deactivated. In some embodiments, the embedded system 120 is deactivated prior to removing the off-board memory, while in other embodiments the embedded system does not have to be powered down or deactivated prior to swapping out the external memory containing the root file system used by the operating system allowing hot swapping of external memory. In step 714, the off-board memory containing the root file system that the operating system previously used to boot is removed. Alternatively, in some embodiments, the monitor may be reconfigured to pass a location of a new or alternate root file system to the operating system during rebooting rather than swapping out the local off-board memory 210 containing the old root file system. In step 716, a new root file system for booting the operating system is provided in a local off-board memory. For example, in some embodiments, if the local off-board memory 210 comprises a flash memory, a new root file system is copied onto the flash memory or alternatively, the flash memory could be swapped for another flash memory containing a new root file system.

In step 720, the embedded system 120 is activated (powered up or reset) causing the board to begin initializing itself for operation. Step 720 includes the controller 260 beginning execution of the monitor 228 which initializes the operating system of embedded system 120. In step 730, the monitor 228 copies the operating system 224 from the onboard non-volatile memory into the onboard active memory 280. In step 740, the monitor 228 activates the operating system and directs the operating system to use the new or alternate off-board root file system 230 in the local off-board memory 210. In step 745, the operating system mounts the root file system in the off-board memory in order to make the contents of the file system available to the operating system as if they were in local memory. In step 750, the operating system accesses the off-board memory 210 through the external memory access 290 in order to locate the root file system 230. Then in step 760, the copied operating system 254 boots using the root file system 230 of the local off-board memory to configure itself. In step 770, the copied operating system 254 begins controlling at least part of the execution of the controller 260. Finally, in step 780, the operating system initializes one or more application programs that are part of the root file system and that the operating system was configured to initialize in order to perform one or more designated functions of the embedded system 120.

FIG. 8 depicts a simplified block diagram of an embodiment of a consumer electronic device 110 similar to that depicted in FIG. 1. However, the consumer electronic device 110 in the present embodiment additionally comprises one or more internal ports 810 and one or more external ports 160. The embedded system 120 accesses the internal ports 810 through one or more data busses 140 internal to the consumer electronic device 110. The external memory access 290 of the embedded system is configured to access the internal ports 810 in order to access an off-board memory 820 that is internal to the consumer electronic device 110 and is coupled to one of the internal ports 810. The external memory may comprise a non-volatile memory such as, for example, a USB flash device. In other embodiments, the external memory access 290 is configured to access the external ports 160 in order to access an off-board memory 830 that is external to the consumer electronic device 110 such as, for example, a USB flash drive coupled to one of the external ports.

The present embodiment demonstrates that the embedded system may be configured to boot from a root file system accessed on an external memory device coupled to a port either internal to or external to the consumer electronic device. For example, the consumer electronic device may comprise one or more internal ports 810 (such as USB ports, bus ports or other such ports) and one or more embedded systems 120 with similar or duplicate hardware. Each embedded system is then configured to access a specific port in order to access a root file system for booting the embedded system. At least some of the functions of each of the embedded systems are determined by coupling, for example, a USB flash drive containing an appropriate root file system containing configuration files for the operating system in addition to application programs for the operating system to execute. Consumer electronic device manufacturers may realize significant cost savings from the present embodiments because the device can be constructed from“standard” embedded system components and USB flash memories with specialized root file systems for determining the function of the embedded system components.

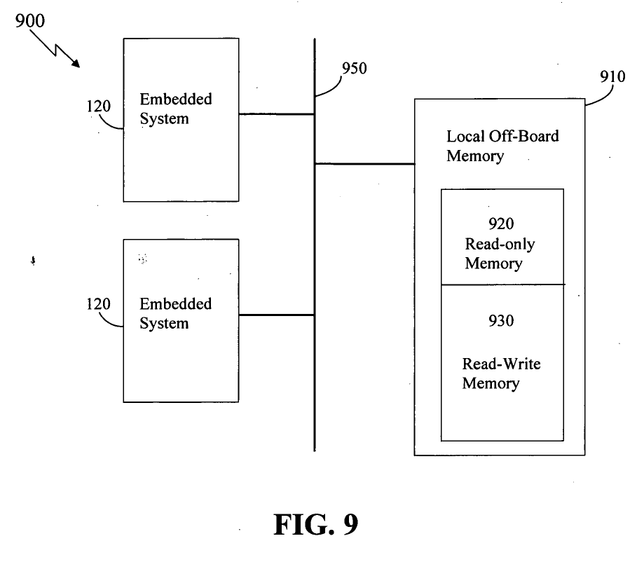

FIG. 9 depicts a simplified block diagram of an electronic device 900 according to some embodiments having two embedded systems 120 accessing a root file system in a local off-board memory 910. The present embodiment is limited to two embedded systems merely for illustrative purposes. Alternate embodiments may incorporate more than two embedded systems sharing the same or different root file systems.

The present embodiment comprises two embedded systems 120, a local off-board memory 910 and a data bus 950. The local off-board memory includes a read-only root file system that the operating systems of each of the embedded systems 120 access while booting. The off-board memory further includes a writeable memory or portion of memory 930 usable by the embedded systems. Each of the embedded systems in some implementations is allocated a block of memory where the operating system of the embedded system can write data. The blocks of writeable memory are allocated exclusively to each embedded system in order to prevent conflicts between the simultaneously running embedded systems. A benefit of the present embodiment is that each of the embedded systems in the electronic device 900 could utilize the same read-only file system in a read-only memory or portion of memory 920 if the embedded systems perform the same function. As a result, if the root file system used by the embedded systems were to be updated, only a single external memory device would have to be replaced to provide a new root file system or the root file system onboard a single external memory device would have to be updated.

While the invention herein disclosed has been described by means of specific embodiments and applications thereof, numerous modifications and variations could be made thereto by those skilled in the art without departing from the scope of the invention set forth in the claims.

What is claimed is:

1. An embedded system comprising:
a circuit board comprising:
a processor;
a memory;
an operating system stored in the memory and utilized to at least in part control processor operation; and
an external memory access comprising:
a first port onboard the circuit board;
a local off-board memory, wherein the local off-board memory is coupled to the first port; and
a root file system stored in the local off-board memory used while booting the operating system.

2. The system of claim 1, wherein the first port supplies power to the local off-board memory.

3. The system of claim 1, wherein the local off-board memory comprises a USB flash drive.

4. The system of claim 1, wherein the external memory access further comprises:
a second port wherein the second port is located off-board the circuit board and the local off-board memory is coupled to the second port rather than the first port, and the first port accesses the local off-board memory coupled to the second port.

5. The system of claim 4, wherein the first and second ports are USB ports and the local off-board memory is a USB flash drive.

6. The system of claim 4, wherein the second port supplies power to the local off-board memory.

7. The system of claim 1, further comprising:
a monitor, wherein the monitor is executed by the processor when the circuit board is powered up or reset and the monitor initializes execution of the operating system; and
a parameter in the onboard memory, wherein the monitor is configured to read the parameter to determine whether to direct the operating system to access the first root file system stored in the local off-board memory.

8. The system of claim 7, further comprising a root file system in the onboard memory that the operating system uses while booting when the parameter in the onboard memory is configured to instruct the operating system on use a root file system in the memory of the circuit board instead of the root file system in the local off-board memory.

9. A method for booting an embedded system comprising:
activating a circuit board;
initiating execution of the operating system;
directing the operating system to use a first root file system located in a local off-board memory;
accessing the local off-board memory; and
booting the operating system using the root file system in the local off-board memory.

10. The method of claim 9, wherein the local off-board memory is coupled to a port and said port powers the local off-board memory.

11. The method of claim 9, wherein the accessing comprises accessing the local off-board memory through a USB port.

12. The method of claim 11, wherein the local off-board memory is a USB flash drive.

13. The method of claim 9, further comprising:
determining a state of a parameter such that the directing the operating system comprises directing the operating system to use the first root file system located in the local off-board memory when the parameter defines a first state, and alternatively directing the operating system to use an onboard root file system stored in the onboard non-volatile memory when the parameter defines a second state.

14. The method of claim 13, further comprising:
copying the onboard root file system from the onboard non-volatile memory to the onboard active memory to create a copied root file system when the parameter defines the second state indicating that the onboard root file system is to be copied from the onboard non-volatile memory; and
directing the operating system to use the copied root file system in the onboard active memory instead of using the first root file system located in the local off-board memory.

15. The method of claim 9, further comprising the steps of:
resetting the circuit board;
directing the operating system to use a second root file system located in a second local off-board memory;
accessing the second root file system; and
re-booting the operating system using the second root file system in the second local off-board memory.

16. A consumer electronic device comprising:
an embedded system comprising:
a processor;
a memory;
an operating system stored in the memory and utilized to at least in part control processor operation; and
an external memory access configured to allow access to a first off-board root file system used while booting the operating system;
a first port communicationally coupled with the embedded system; and
a first local off-board memory coupled to the first port, wherein the first local off-board memory contains the first off-board root file system accessible by the embedded system through the external memory access for use in booting the operating system of the embedded system.

17. The consumer electronic device of claim 16, wherein the first local off-board memory receives power from the first port.

18. The consumer electronic device of claim 16, wherein the first port is a USB port and the first local off-board memory is a USB flash drive.

19. The device of claim 16, further comprising:
a second port communicationally coupled with the embedded system;
a second local off-board memory coupled to the second port, wherein the second local off-board memory comprises a second off-board root file system; and
a means for defining which of the first and of the second ports are to be utilized by the embedded system while booting.
